(19) United States
(12) Patent Application Publication
(10) Pub. No.: US 2004/0133420 A1
(43) Pub. Date: Jul. 8, 2004

(54) Method of analysing a compressed signal for the presence or absence of information content

(76) Inventors: Gavin Robert Ferris, London (GB); Michael Vincent Woodward, London (GB)

Correspondence Address: Richard C Woodbridge, Synnestvedt Lechner & Woodbridge, Post Office Box 592, Princeton, NJ, 08542-0592, US

(21) Appl. No.: 10/467,545

(22) PCT Filed: Feb. 8, 2002
(86) PCT No.: PCT/GB02/00559

(30) Foreign Application Priority Data
Feb. 9, 2001 (GB) 0103242.4

(51) Int. Cl. G10L 11/06

(52) U.S. Cl. 704/215

(57) ABSTRACT

Compressed signals contain amplitude data (for example, scale factors in an MPEG frame) which can be examined to enable a decision to be taken on whether the signal contains information or not (e.g. silence in the case of audio or no image in the case of video).

### BACKGROUND TO THE INVENTION

1. Field of the Invention

This invention relates to a method of analysing a compressed signal for the presence or absence of information content. For example, the invention may detect silence in compressed audio signals and/or detect the absence of an image in compressed video signals. The method is equally applicable to signals taken from analogue or digital sources.

2. Description of the Prior Art

Being able to detect the presence or absence of information content in a compressed signal is a common requirement in many systems. For example, the compressed digital audio output from equipment used in broadcasting digital radio is usually monitored so that any silences lasting more than a set time period can be investigated in case they indicate a human error, or a software or equipment failure. More specifically, analysing a compressed signal for the presence or absence of information content may be used to detect when an audio service is no longer supplying audio to a DAB (Digital Audio Broadcasting) multiplexer, or in a video multiplexer to detect when one of the video channels suffers an audio or video loss.

There are two existing techniques for detecting loss of audio/video. The first technique looks for the presence of absence of, for example, MPEG frames, e.g. by checking that an incoming bitstream is valid according to the expected format. This check is necessary, but not sufficient. It is possible that the incoming data is in the correct format, but is silent and/or blank, and this technique will not detect this case. GB 2341746A exemplifies this approach. The second technique looks at the data content. The conventional approach to monitoring for losses of data in a compressed signal involves first fully decompressing the signal to a digital format (e.g. rendering it to PCM in the case of audio). It is the decompressed, digital signal which is then examined for silence (if audio) or lack of an image (if video) by comparing the decompressed digital signal against pre-set thresholds indicative of the presence or absence of information. If the compressed signal was taken from a digital source (e.g. a digital audio feed from a CD player), then this detection is relatively straightforward: the compressed signal is decompressed and the resultant PCM signals examined for events of zero amplitude: these correspond to the absence of any information content (e.g. silence in audio signal), which may indicate a human error, or a software or equipment failure. If the signal was sourced from an analogue source prior to digitisation, then the procedure is more complex. An analogue source will never give true silence or lack of image. This analogue signal will pass through a digitising system and in most cases the resulting compressed signal will not be a ‘digital zero’ even when no genuine information is being carried. Hence, when decompressed, the resultant digital signal will also not be a digital zero even when no genuine information is being carried. In this case, the silence detecting system will have to apply some threshold based algorithm for deciding whether the signal contains data or not.

Although decompression is usually designed to be easier than compression, the decompression overhead is still significant. This will be especially true for systems that process data from many sources (e.g. video or audio multiplexers).

Whilst silence detection could be done at the digitising system, this may not be appropriate. The broadcaster might not be the same as the organisation providing the audio or data stream (as is often the case in DAB or in cable television). The multiplexing system may also be some considerable distance from the digitising system. So there is a clear need for a broadcaster to detect loss of information content which is separate from the digitising process. This could be performed as part of the multiplexing operation, or in a separate system.

### SUMMARY OF THE PRESENT INVENTION

In accordance with the present invention, a method of analysing a compressed signal for the presence or absence of information content comprises the steps of:

(a) examining amplitude data coded in the compressed signal;

(b) determining the presence or absence of information content in the compressed signal in dependence on the results of the amplitude examination.

Hence the present invention is predicated on the insight that compressed signals contain amplitude data which can be examined to enable a decision to be taken on whether the signal contains information or not (e.g. silence in the case of audio or no image in the case of video). Hence, compressed signals do not have to be decompressed with the present invention to enable content loss detection to occur, unlike prior art approaches.

In one implementation, where the compressed signal is a MPEG audio frame, the amplitude information is coded as ‘scale factors’. Extraction and examination of these scale factors is computationally straightforward, so that a silence detection process based on scale factor analysis is faster and more efficient than conventional systems requiting a full decompression to PCM.

In other aspects of the invention, there are:

Computer software adapted to perform the above inventive methods;

Computer hardware adapted to perform the above inventive methods;

Chip level devices adapted to perform the above inventive methods (e.g. DSPs or FPGAs).

### BRIEF DESCRIPTION OF THE DRAWINGS

FIG. 1 shows a flowchart for an implementation of the current invention.

### DETAILED DESCRIPTION

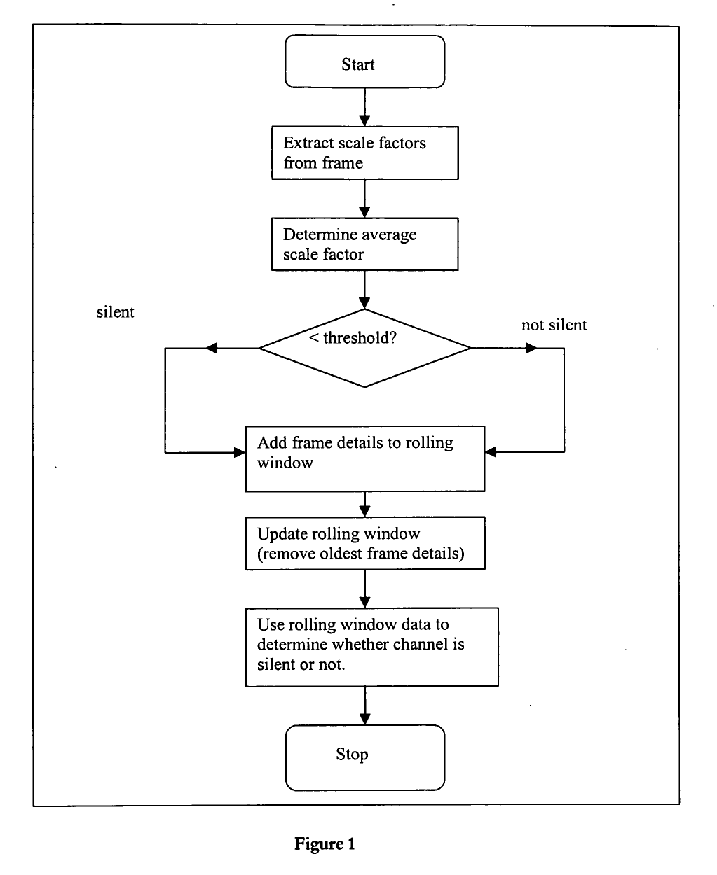

This description will be in terms of silence detection in MPEG audio frames. As noted above, the present invention can be applied to many other different signal types. A flow diagram of the MPEG related process is shown in FIG. 1.

The invention is based on the application of the following key ideas:

1. Detection of silence of an individual frame using amplitude information contained in the frame;

2. Using a rolling window to determine whether the silence is on going or not.

An MPEG audio frame [ISO 11172-3, Information technology—Coding of moving pictures and associated audio for digital storage media at up to about 1.5 Mbit/s—part 3: audio, 1993] contains data sampled in the time domain and transformed into the frequency domain. The frequencies so obtained are grouped together into subbands and amplitude information for these subbands is calculated. This amplitude information is known as the scale factors. Hence, a MPEG audio frame includes amplitude information coded as scale factors.

An analogue silence will have some random fluctuations, but the scale factor indices during silence will tend to be high (meaning that the scale factors themselves will tend to be low).

The present implementation calculates an average scale factor for all subbands with non-zero bit allocation. If this mean scale factor is less than a threshold, then the frame is considered silent. (Median or mode values can be used in place of mean in certain circumstances). The threshold value can be determined by experimentation with equipment that digitises analogue signals, and the value can be changed by the user (values of 0.0001 or −50 dB may be used, but note that the threshold values will change depending on the analogue/digital systems used).

Detecting a single silent frame is useful of itself, but does not mean that the audio stream as a whole is silent: there will always be short periods of silence in any audio broadcast. For example, there may be a short silence in a pop record, or there may be a silence at the end of a piece of classical music befote the presenter speaks. These silences will be short, but they will be longer than a single MPEG audio frame. They do not indicate human error, or a software or equipment failure. We therefore need some means for reliably discriminating between a stream that has occasional silences which form a part of the broadcast, and a stream which is genuinely silent (perhaps due to a communications breakdown).

An implementation uses individual frame silences coupled with a rolling window technique to achieve this. A rolling window keeps a history of the silence status of the last N frames (where N is an integer, typically being 32-100 for a 24 ms frame length). As details for a new frame are added, the details of the oldest frame are removed. This implementation then considers the stream to be silent if S of the last N frames have been silent or if there have been S contiguous frames of silence. Both of these algorithms have been tried, but the first algorithm gives more reliable results. The integers S and N are configurable by the user and may depend on the equipment used and by regulatory or contractual requirements

Because this algorithm does not rely on fixed values, the broadcaster or user has great flexibility. If it wishes to set an alarm after 10 seconds of silence, this can be done. If it later wishes to change this to 5 seconds, this can easily be done in the field. If the broadcaster purchases a piece of ‘noisy’ digitising equipment, the silence detection threshold can be raised.

In one preferred embodiment an adaptive or learning mode is envisaged which will enable the user to detect the silence detection parameters automatically.

It is very easy to extract scale factor information from MPEG audio frames (using scale factor indices or values), and the rolling window technique has a very low CPU overhead.

Therefore this invention may be applied without adding very much to the processing requirements of a system.

This level of flexibility has not been available prior to this invention.

1. A method of analysing a compressed signal for the presence or absence of information content comprising the steps of:
examining amplitude data coded in the compressed signal;
determining the presence or absence of information content in the compressed signal in dependence on the results of the amplitude examination.

2. The method of claim 1 in which the examination of the amplitude data coded in the compressed signal involves a comparison to a threshold value.

3. The method of claim 2 in which the examination of the amplitude data coded in the compressed signal varies dynamically in dependence on the history of the signal.

4. The method of claim 1 in which the amplitude data is coded as scale factors.

5. The method of claim 4 in which an average scale factor for a given frame, being a mean, median or mode, is used in the amplitude examination.

6. The method of claim 4 in which scale factor indices are used in the amplitude examination.

7. The method of claim 4 in which scale factor values are used in the amplitude examination.

8. The method of claim 1 in which a roling window technique is used in the amplitude examination.

9. The method of claim 8 in which the silence of the last S of N frames is used in the step of determining the presence or absence of information content in the compressed signal.

10. The method of claim 8 where silence of the last S contiguous frames of N frames is used in the step of determining the presence or absence of information content in the compressed signal.

11. The method of claim 8 in which the absence of an image in the last S of N frames is used in the step of determining the presence or absence of information content in the compressed signal.

12. The method of claim 8 in which the absence of an image in the last S contiguous frames of N frames is used in the step of determining the presence or absence of information content in the compressed signal.

13. The method of any preceding claim 8, 9, 10, 11, or 12 where the parameters S and/or N are set by the user.

14. The method of any preceding claim 8, 9, 10, 11, or 12 where the parameters S and/or N are adaptively learned by an algorithm.

15. Computer software adapted to perform the method of any preceding claim 1-14.

16. Computer hardware adapted to perform the method of any preceding claim 1-14.

17. A chip level device adapted to perform the method of any preceding claim 1-14.
